(19) United States
(12) Patent Application Publication
(10) Pub. No.: US 2011/0205872 A1
(43) Pub. Date: Aug. 25, 2011

(54) OPTICAL DISC DRIVE AND METHOD OF CONTROLLING THE SAME

(76) Inventors: Hiroharu Sakai, Tokyo (JP); Hajime Nishimura, Tokyo (JP); Shuichi Minamiguchi, Tokyo (JP)

(21) Appl. No.: 13/034,436

(22) Filed: Feb. 24, 2011

(30) Foreign Application Priority Data
Feb. 24, 2010 (JP) 2010-038532

(51) Int. Cl. G11B 7/09

(52) U.S. Cl. 369/44.27; G9B/7.076

(57) ABSTRACT

An optical disc drive for reading or writing information on a multilayer optical disc having a plurality of recording layers by irradiating the disc with a light beam includes an optical pickup for irradiating the disc with the light beam, a focus error signal generator for generating a focus error signal that indicates a state of displacement of a focal point of the light beam from a recording layer based on reflection from the disc, a recording state detector for detecting a data recording state at a landing point of the focal point in a focus jump, a threshold setting unit for setting a threshold to be compared with the focus error signal based on the data recording state at the landing point, and a focus jump controller for controlling the focus jump based on a result of comparison of the focus error signal with the threshold.

### CLAIM OF PRIORITY

The present application claims priority from Japanese patent application JP 2010-38532 filed on Feb. 24, 2010, the content of which is hereby incorporated by reference into this application.

### BACKGROUND OF THE INVENTION

This invention relates to an optical disc drive and, in particular, relates to a focus control technique in irradiating a multilayer optical disc having a plurality of recording layers with a light beam to read or write information therein.

An optical disc drive that reads or writes information in an optical disc such as CD (Compact Disc), DVD (Digital Versatile Disc), and BD (Blu-ray Disc) spins an optical disc at high speed, irradiates an information recording surface of the spinning optical disc with laser light, and detects the reflection of the laser light to read or write information.

JPH11-39665A, JP2004-63025A, and JP2006-313591A disclose optical disc drives that are capable of reading information from or writing information to multilayer optical discs having a plurality of recording layers. In particular, JPH11-39665A discloses a technique that determines a threshold level for detecting a zero cross point in a focus error signal depending on a variation in level of the focus error signal in controlling a focus jump, which is to move a focal point of laser light to a different recording layer. JP2004-63025A discloses a technique in focus jump control that finds out distribution of recorded areas and unrecorded areas in an optical disc to achieve a stable access to a target position on a recording layer while avoiding the unrecorded areas. JP2006-313591A discloses storing information on recording states in a management information area of an optical disc.

### SUMMARY OF THE INVENTION

In irradiating a multilayer optical disc having a plurality of recording layers with a light beam to detect the reflection, a reflection signal from an area with information recorded is different in level from a reflection signal from an area without information recorded. In JPH11-39665A, JP2004-63025A, and JP2006-313591A, however, it is not considered whether the destination of a focus jump is in an area with data recorded or not in controlling the focus jump.

This invention has been made in view of the above-described problem and an object of this invention is to provide a technique that controls a focus jump in a multilayer optical disc depending on whether the destination of the focus jump is in a recorded area or an unrecorded area.

A representative aspect of this invention is as follows. That is, there is provided an optical disc drive for reading or writing information on a multilayer optical disc having a plurality of recording layers by irradiating the multilayer optical disc with a light beam comprising: an optical pickup for irradiating the multilayer optical disc with the light beam, a focus error signal generator for generating a focus error signal that indicates a state of displacement of a focal point of the light beam from a recording layer of the multilayer optical disc based on reflection from the multilayer optical disc, a recording state detector for detecting a data recording state at a landing point of the focal point of the light beam in a focus jump where the focal point of the light beam is moved to a target recording layer, a threshold setting unit for setting a threshold to be compared with the focus error signal based on the data recording state at the landing point of the focal point of the light beam, and a focus jump controller for controlling the focus jump based on a result of comparison of the focus error signal with the threshold set by the threshold setting unit.

Another representative aspect of this invention is as follows. That is, there is provided an optical disc drive for reading or writing information on a multilayer optical disc having a plurality of recording layers by irradiating the multilayer optical disc with a light beam comprising: an optical pickup for irradiating the multilayer optical disc with a light beam, a focus error signal generator for generating a focus error signal that indicates a state of displacement of a focal point of the light beam from a recording layer of the multilayer optical disc based on reflection from the multilayer optical disc, a recording state detector for detecting a data recording state at a landing point of the focal point of the light beam in a focus jump where the focal point of the light beam is moved to a target recording layer, a signal adjuster for adjusting a level of the focus error signal based on the data recording state at the landing point of the focal point of the light beam, and a focus jump controller for controlling the focus jump based on a result of comparison of the focus error signal adjusted by the signal adjuster with a predetermined threshold.

Yet another representative aspect of this invention is as follows. That is, there is provided a method of controlling an optical disc drive for reading or writing information on a multilayer optical disc having a plurality of recording layers by irradiating the multilayer optical disc with a light beam, comprising the steps of: generating a focus error signal that indicates a state of displacement of a focal point of the light beam from a recording layer of the multilayer optical disc based on reflection from the multilayer optical disc, detecting a data recording state at a landing point of the focal point of the light beam in a focus jump where the focal point of the light beam is moved to a target recording layer, setting a threshold to be compared with the focus error signal based on the data recording state at the landing point of the focal point of the light beam, and controlling the focus jump based on a result of comparison of the focus error signal with the threshold.

Yet another representative aspect of this invention is as follows. That is, there is provided a method of controlling an optical disc drive for reading or writing information on a multilayer optical disc having a plurality of recording layers by irradiating the multilayer optical disc with a light beam; comprising the steps of: generating a focus error signal that indicates a state of displacement of a focal point of the light beam to a recording layer of the multilayer optical disc based on reflection from the multilayer optical disc, detecting a data recording state at a landing point of the focal point of the light beam in a focus jump where the focal point of the light beam is moved to a target recording layer, adjusting a level of the focus error signal based on the data recording state at the landing point of the focal point of the light beam, and controlling the focus jump based on a result of comparison of the adjusted focus error signal with a predetermined threshold.

According to a representative embodiment of this invention, appropriate thresholds to be compared with a focus error signal can be set depending on whether the destination of a focus jump is in a recorded area or an unrecorded area; consequently, an accurate focus jump can be achieved.

### BRIEF DESCRIPTION OF THE DRAWINGS

The present invention can be appreciated by the description which follows in conjunction with the following figures, wherein:

FIG. 1 is a block diagram illustrating a configuration of an optical disc drive in a first embodiment;

FIG. 2A to FIG. 2D are diagrams schematically illustrating examples of sum signals (RF signals) and focus error signals (FE signals);

FIG. 3 is a flowchart illustrating a procedure to be executed by the optical disc drive in the first embodiment;

FIG. 4 is a diagram illustrating a transit point on a transit layer and a focus landing point when the current focus point of laser light is on a layer L2 and the access target point is on a layer L0;

FIG. 5 exemplifies thresholds Va and Vb for focus jump control together with a drive signal and a focus error signal at an inter-layer jump in a conventional focus jump control;

FIG. 6 is a diagram showing a drive signal and a focus error signal during an inter-layer jump operation from the layer L2 to the layer L0 in a conventional focus jump control;

FIG. 7 is a diagram to explain a method of setting the thresholds Va and Vb based on a recording state at a focus landing point in the first embodiment;

FIG. 8 is a diagram to explain the timing to set (change) the thresholds Va and Vb based on the recording state at the focus landing point;

FIG. 9 is a flowchart illustrating a procedure to be executed by the optical disc drive in a second embodiment;

FIG. 10 is a diagram to illustrate a method of adjusting the value of the focus error signal based on the recording state at the transit point on the transit layer;

FIG. 11 is a diagram for illustrating a method of controlling a focus jump when the expected focus landing point is in the border between an area with data recorded and an area without data recorded;

FIG. 12 is a diagram for illustrating a method of controlling a focus jump when the transit point on the transit layer is in the border between an area with data recorded and an area without data recorded; and

FIG. 13 is a flowchart illustrating a procedure executed by an optical disc drive in a third embodiment.

### DETAILED DESCRIPTION OF THE EMBODIMENTS

Hereinafter, preferred embodiments will be explained with reference to the accompanying drawings.

### First Embodiment

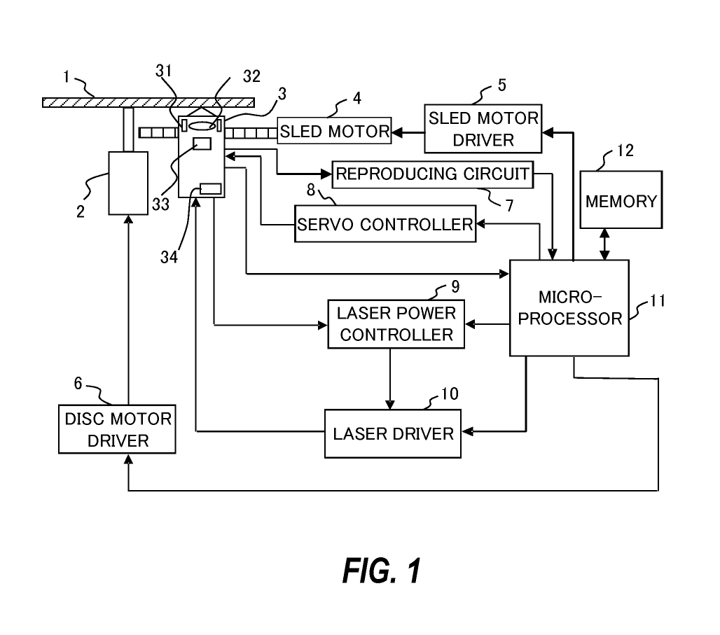

FIG. 1 is a block diagram illustrating a configuration of an optical disc drive in a first embodiment. The optical disc drive in the first embodiment comprises a disc motor 2, an optical pickup 3, a sled motor 4, a sled motor driver 5, a disc motor driver 6, a reproducing circuit 7, a servo controller 8, a laser power controller 9, a laser driver 10, a microprocessor 11, and a memory 12.

The disc motor 2 is driven by the disc motor driver 6 to rotate an optical disc 1. The optical disc 1 is a multilayer optical disc having a plurality of recording layers, for example, a BD, although not limited to a BD. The disc motor driver 6 controls the rotation (rotating/stopping, and the rotation speed) of the disc motor 2 in response to instructions of the microprocessor 11.

The optical pickup 3 includes an actuator 31, an object lens 32, a laser 33, a front monitor 34, and further, an optical receiver and a beam splitter not shown. The laser 33 is a semiconductor laser (light emitter) for emitting laser light of a predetermined intensity for reading or writing. The laser light emitted from the laser 33 impinges on the recording surface (optical disc surface) of the optical disc 1 through the object lens 32. The optical receiver receives the laser light reflected on the recording surface of the optical disc 1, converts the received reflection into an electrical signal, and outputs the converted electrical signal. The object lens 32 is driven and adjusted by the actuator 31 to focus the laser light on the surface of the optical disc. The actuator 31 is driven by the servo controller 8.

The laser light emitted by the laser 33 is split by the beam splitter, for example, and is led to the front monitor 34. The front monitor 34 monitors the power of the laser light based upon the split laser light.

The reproducing circuit 7 reproduces data (information) based on the electrical signal output by the optical pickup 3 and also generates a tracking error signal and a focus error signal. The tracking error signal is to indicate displacement of laser light from a track on the optical disc 1 and the focus error signal is to indicate displacement of the focal point of laser light from a recording surface (recording layer) of the optical disc 1.

The servo controller 8 controls focus servo and tracking servo. The focus servo controls the object lens 32 to focus laser light on the recording surface of the optical disc 1 by driving the actuator 31. The tracking servo controls the optical pickup 3 to follow a track of the optical disc 1.

The laser power controller 9 controls the output power of laser light in accordance with a laser power preliminarily recorded in the optical disc 1 or determined by OPC (Optimum Power Control). The laser power controller 9 also controls laser light in accordance with a laser power predetermined for reading. The laser driver 10 is a drive circuit for driving the laser 33. The laser driver 10 is controlled by the laser power controller 9.

The microprocessor 11 controls operations of the optical disc drive. For example, it instructs the servo controller 8 to control a focus jump. The memory 12 stores a program to be executed by the microprocessor 11 and data necessary to execute the program.

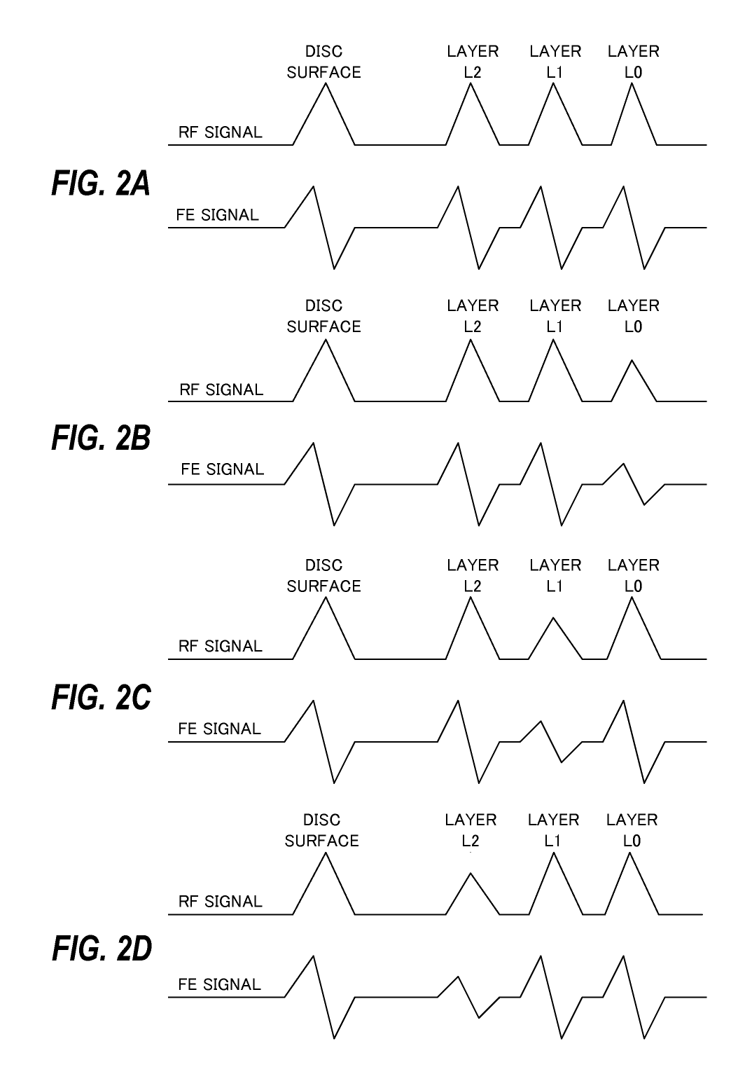

FIG. 2A to FIG. 2D are diagrams schematically illustrating examples of sum signals (RF signals) and focus error signals (FE signals) generated by the reproducing circuit 7 during focus jump operations. In these examples, the optical disc 1 has three recording layers: the deepest layer from the surface of the optical disc 1 on the recording plane side called layer L0, the layer one above the layer L0 called layer L1, and the layer closest to the disc surface called layer L2. It should be noted that this invention is not limited by such nominal designations of recording layers.

In each of FIG. 2A to FIG. 2D, the upper signal is the sum signal (RF signal) and the lower signal is the focus error signal (FE signal). The parts where the waveforms of the sum signal and the focus error signal show abrupt changes correspond to, in order from the leftmost, the reflections from the disc surface, the layer L2, the layer L1, and the layer L0.

FIG. 2A shows the signals in the case of all the three recording layers having no data recorded. FIG. 2B shows the signals in the case of only the layer L0 having data recorded and the layers L1 and L2 having no data recorded. FIG. 2C shows the signals in the case of only the layer L1 having data recorded and FIG. 2D shows the signals in the case of only the layer L2 having data recorded. As seen from comparison of FIG. 2A with FIG. 2B, the values of the sum signal and the focus error signal on the layer L0 with data recorded are smaller than the signal values on the layers L1 and L2 without data recorded. Similarly, in the case where data is recorded in the layer L1 (FIG. 2C), the values on the layer L1 are small, and in the case where data is recorded in the layer L2 (FIG. 2D), the values on the layer L2 are small. In this way, the sum signal and the focus error signal show smaller values on the layers with data recorded than the layers without data recorded.

Accordingly, in controlling a focus jump, which is to move the focal point of laser light to a different recording layer, the optical disc drive in the first embodiment sets the level of a threshold to be compared with the focus error signal depending on the data recording state of the focus jump destination area and the data recording state of a transit area where the focal point passes through on a transit recording layer through which the focal point passes.

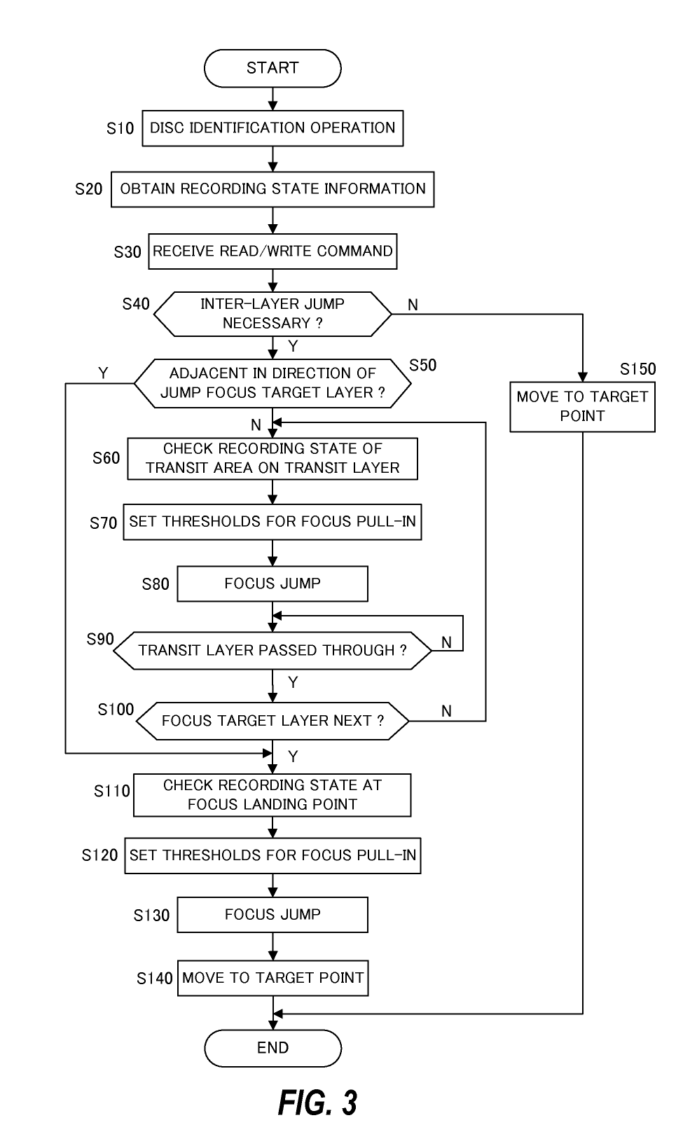

FIG. 3 is a flowchart illustrating a procedure to be executed by the optical disc drive in the first embodiment. Upon loading of the optical disc 1, the optical disc drive starts the process of step S10.

After performing a predetermined disc identification operation at the step S10, the optical disc drive obtains information on the recording state of each data area at step S20. The information on the recording state of each data area includes at least information indicating whether data has been recorded or not in the data area. For example, if the disc is a BD, the information on the recording state of each data area can be obtained from SRRI (Sequential Recording Range Information), which is a kind of information included in a disc management area provided in the inner diameter or the outer diameter of the optical disc 1. For example, if the disc includes recorded data, the SRRI includes one or more pieces of positional information (addresses) each indicating the start and the end of an area with data recorded. Accordingly, the optical disc drive can obtain positional information on the start and the end of each recorded area to know the recording state of each data area.

When the optical disc drive receives a data read command or a data write command at step S30, the procedure proceeds to step S40. At the step S40, the optical disc drive determines whether an inter-layer jump, or a shift to another recording layer, is necessary or not to move the focal point of laser light to the access target address. If it determines that an inter-layer jump is unnecessary, the procedure proceeds to step S150. At the step S150, the optical disc drive controls the focal point of laser light to move to the target position on the same recording layer.

On the other hand, if the optical disc drive determines that an inter-layer jump is necessary at the step S40, the procedure proceeds to step S50. At the step S50, the optical disc drive determines whether the recording layer adjacent in the direction of the jump is the focus target layer that includes the access target point. If the optical disc drive determines that the recording layer adjacent in the direction of the jump is the focus target layer, the procedure proceeds to step S110. If the optical disc drive determines that it is not the focus target layer but a transit layer, the procedure proceeds to step S60.

At the step S60, the optical disc drive checks the recording state of the transit point on the transit layer.

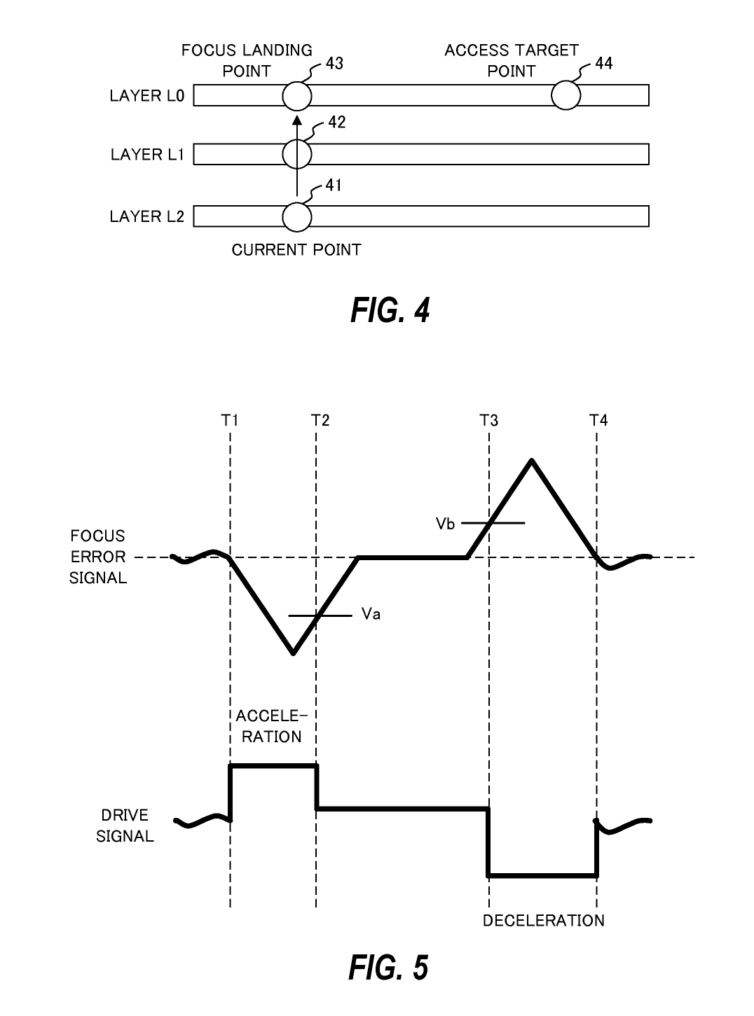

FIG. 4 is a diagram illustrating a transit point 42 on a transit layer and a focus landing point 43 when the current focus point 41 of laser light is on the layer L2 and the access target point 44 is on the layer L0. In this case, the layer L1 is a transit layer.

The optical disc drive in this embodiment first performs a focus jump where the focal point of laser light is moved from the current focus point (initial point) 41 of laser light to the recording layer including the access target point 44, and then controls the focal point of the light to move from the focus landing point 43 to the access target point 44. It calculates the radius in the vicinity of the current focus point 41 from the sector information read from the optical disc 1 by the reproducing circuit 7 in the vicinity of the focus point 41 and calculates the address at the same radial position on the transit layer to obtain the address of the transit point 42 on the transit layer. The optical disc drive refers to the information on the recording state of each data area obtained at the step S20 based upon the address of the obtained transit point 42 to check the recording state at the transit point on the transit layer.

At step S70, the optical disc drive sets thresholds necessary for focus pull-in operations based on the recording state at the transit point on the transit layer checked at the step S60. The thresholds necessary for focus pull-in operations are to be compared with the focus error signal and include a threshold for recording layer detection, a threshold for recording layer transit determination, and a threshold for focus jump control.

FIG. 5 exemplifies thresholds Va and Vb for focus jump control together with a drive signal and a focus error signal at an inter-layer jump in a conventional focus jump control. It should be noted that the threshold Va for focus jump control also works as a threshold for recording layer transit determination, and the threshold Vb for focus jump control also works as a threshold for recording layer detection. In this description, an inter-layer jump operation from the layer L1 to the layer L0 will be described by way of example.

Upon receipt of an inter-layer jump command, the microprocessor 11 outputs an acceleration signal to move the object lens 32 closer to the optical disc 1 (time T1). The object lens 32 moves toward the optical disc 1 in accordance with the acceleration signal so that the focus error signal turns to the negative side.

Thereafter, the microprocessor 11 detects a negative peak of the focus error signal, and when the focus error signal exceeds the acceleration stop threshold Va, the microprocessor 11 stops outputting the acceleration signal (time T2). As described above, the acceleration stop threshold Va also works as a threshold for recording layer transit determination. When the value of the focus error signal exceeds the threshold Va for recording layer transit determination, the microprocessor 11 determines that the focal point has passed through the layer L1.

After the acceleration signal is stopped, the object lens 32 continues to move because of inertia, so that the focus error signal turns to the positive side. When the focus error signal exceeds the threshold Vb for recording layer detection, it determines that the focal point has entered the layer L0 (time T3).

As described above, the threshold Vb for recording layer detection also works as the threshold for focus jump control. In this description, it is also called a deceleration start threshold Vb. When the focus error signal exceeds the deceleration start threshold Vb, the microprocessor 11 outputs a deceleration signal to stop the object lens 32 (time T3). When the value of the focus error signal becomes zero, it stops outputting the deceleration signal (time T4). Through this series of operations, the optical disc drive moves the focal point of laser light from the layer L1 to the layer L0.

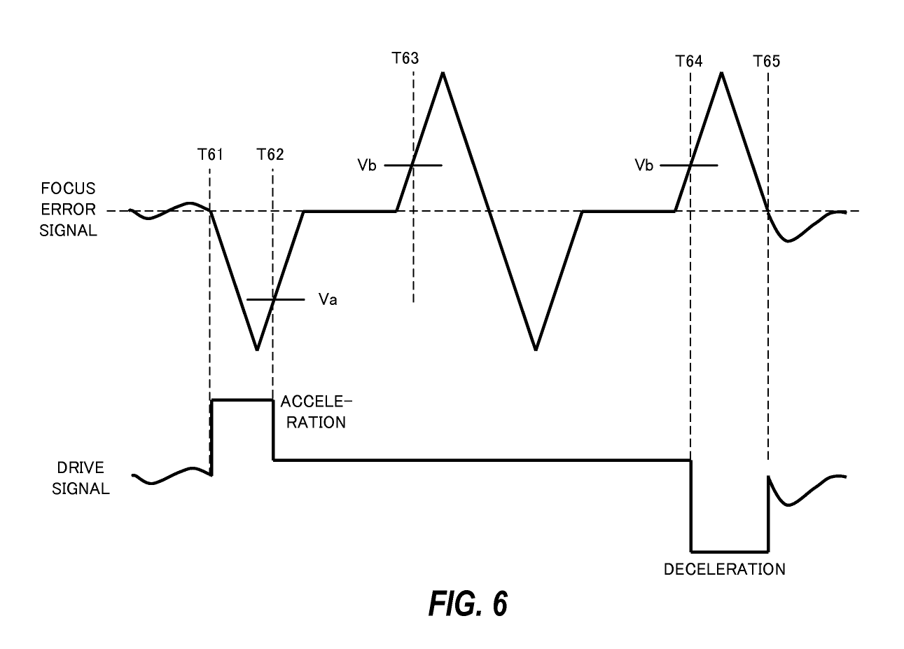

FIG. 6 is a diagram showing a drive signal and a focus error signal during an inter-layer jump operation from the layer L2 to the layer L0 in a conventional focus jump control. After an acceleration signal is output (time T61), the focus error signal reaches a negative peak value and then exceeds the acceleration stop threshold Va. At that time, the microprocessor 11 stops outputting the acceleration signal (time T62). When the value of the focus error signal exceeds the threshold Va for recording layer transit determination, the microprocessor 11 determines that the focal point has passed through the layer L2 (time T62).

When the focus error signal exceeds the threshold Vb for recording layer detection, the microprocessor 11 determines that the focal point has entered the layer L1 (time T63). Then, it detects a positive peak and another negative peak of the focus error signal. The operations after the focus error signal exceeds the threshold Vb for recording layer detection (the deceleration start threshold) again (time T64) are the same as those in FIG. 5.

As described above, the value of the focus error signal in an area with data recorded is smaller than the value in an area without data recorded. Accordingly, in this embodiment, the acceleration stop threshold Va (the threshold for recording layer transit determination) and the deceleration start threshold Vb (the threshold for recording layer detection) are set based on the recording state at the focus landing point and the recording state at the transit point on the transit recording layer.

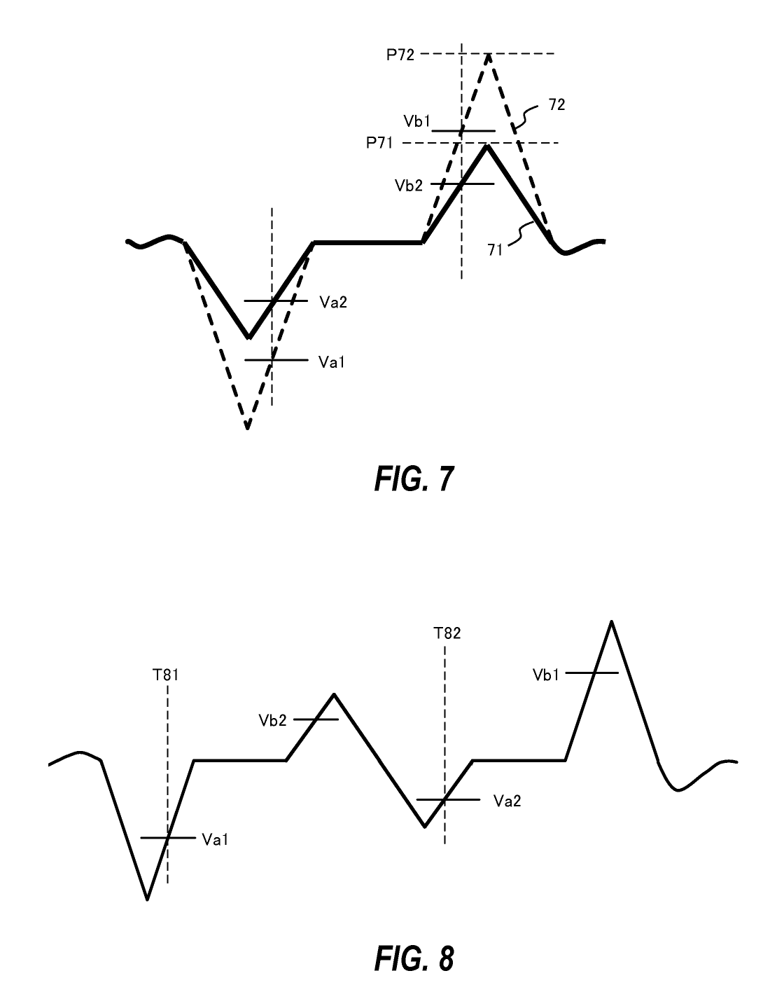

FIG. 7 is a diagram to explain a method of setting the thresholds Va and Vb based on the recording state at the focus landing point. In FIG. 7, a signal 71 denoted by the solid line represents a focus error signal in the case of data recorded and a signal 72 denoted by the dashed line represents a focus error signal in the case of data unrecorded.

In this embodiment, the acceleration stop threshold Va also works as the threshold for recording layer transit determination and the deceleration start threshold Vb also works as a threshold for recording layer detection. The threshold for recording layer transit determination may be provided separately from the threshold Va for focus jump control, and the threshold for recording layer detection may be provided separately from the threshold Vb for focus jump control.

Since the value of the focus error signal is smaller in an area with data recorded than in an area without data recorded, the deceleration start threshold Vb2 (the threshold for recording layer detection) in an area with data recorded is set at a smaller value than the deceleration start threshold Vb1 (the threshold for recording layer detection) in an area without data recorded. In this embodiment, the thresholds Vb1 and Vb2 are set so that detection of a recording layer will be made simultaneously with starting the output of the deceleration signal regardless whether the area has data recorded or not. A method of setting the thresholds Vb1 and Vb2 will be described in detail hereinbelow.

For example, in identifying an optical disc 1 loaded in the optical disc drive, the microprocessor 11 detects the positive peak value P71 in the case of data recorded and the positive peak value P72 in the case of no data recorded. The threshold Vb1 in the case of no data recorded is set in advance and the threshold Vb2 in the case of data recorded is set at Vb1×P71/P72.

If all of the recording layers have the same reflectance, it is sufficient to detect the peak values P71 and P72 in any one of the layers. If they have different reflectance, it is preferable to detect the peak values P71 and P72 in individual recording layers. In other words, the microprocessor 11 calculates the thresholds Vb2 in the case of data recorded for individual recording layers based on the detected peak values P71 and P72.

The thresholds Vb1 and Vb2 may be set at fixed values without detecting the above-described peak values P71 and P72 of the focus error signal. For example, the threshold Vb1 in the case of data recorded may be set at Vb2×k (where k is a predetermined coefficient, for example, 0.5) with respect to the threshold Vb2 in the case of no data recorded.

The acceleration stop threshold Va (the threshold for recording layer transit determination) is set at a negative value. Accordingly, as shown in FIG. 7, the acceleration stop threshold Va2 (the threshold for recording layer transit determination) in an area with data recorded is set at a greater value than the acceleration stop threshold Va1 in an area with no data recorded. In this example, the microprocessor 11 sets the thresholds Va1 and Va2 so that the determination of passing through a recording layer will be made simultaneously with stopping the output of the acceleration signal regardless whether the area has data recorded or not. The thresholds Va1 and Va2 may be set in the same method as the thresholds Vb1 and Vb2.

FIG. 8 is a diagram to explain the timing to set (change) the thresholds Va and Vb based on the recording state at the focus landing point and the recording state at the transit point on the transit layer, showing the focus error signal during an inter-layer jump operation from the layer L2 to the layer L0. In this example, it is assumed that the layer L2 has no data recorded, the layer L1 has data recorded, and the layer L0 has no data recorded.

In this embodiment, the thresholds Va and Vb are set (changed) when it is determined that the focal point has passed through the current recording layer. In the example of FIG. 8, the threshold Va1 for recording layer transit determination (the acceleration stop threshold) is set first since the layer L2 which includes the start position of a focus jump has no data recorded. When the output of the focus error signal exceeds the threshold Va1 for recording layer transit determination (time T81), it determines that the focal point has passed through the layer L2 and sets the thresholds for the next layer L1. In other words, since the transit area on the transit layer L1 is an area with data recorded, the microprocessor 11 sets the threshold Vb2 for recording layer detection and the threshold Va2 for recording layer determination.

When the output of the focus error signal exceeds the threshold Va2 for recording layer transit determination (time T82), the microprocessor 11 determines that the focal point has passed through the layer L1 and sets the threshold for the next layer L0. In other words, since the focus landing area on the focus target layer L0 is an area without data recorded, the microprocessor 11 sets the deceleration start threshold Vb1 (threshold for recording layer detection).

Now returning to the flowchart of FIG. 3, explanations will be continued. At step S80, the optical disc drive performs a focus jump based on the thresholds set at the step S70.

At step S90, the optical disc drive determines whether the focal point has passed through the transit layer or not. As described above, when the focus error signal exceeds the threshold value (Va1 or Va2) for recording layer transit determination set at the step S70, it determines that the focal point has passed through the transit layer. If it determines that the focal point has not passed through the transit layer, it waits for the determination that the focal point has passed through the transit layer, and upon such determination, the procedure proceeds to step S100.

At the step S100, the optical disc drive determines whether or not the next recording layer, or the recording layer adjacent in the direction of the jump to the layer that has been determined to be passed through, is the focus target layer on which the access target point exists. If it determines that the next recording layer is not the focus target layer but a transit layer, the procedure returns to the step S60 and performs operations from the step S60 to the step S90 on the next recording layer. It should be noted that if the focus jump operations have already been started, namely, if the operation at the step S80 has once been performed, the optical disc drive continues to move the focal point in the direction of focusing. If the optical disc drive determines that the next recording layer is the focus target layer, the procedure proceeds to step S110.

At the step S110, the optical disc drive checks the recording state at the focus landing point (in the example shown in FIG. 4, the focus landing point 43). At this step, it refers to the information on the recording state of each data area obtained at the step S20 based upon the address of the focus landing point to check the recording state at the focus landing point.

At step S120, the optical disc drive sets the thresholds necessary for focus pull-in operations based on the recording state at the focus landing point checked at the step S110. Since the method of setting the thresholds based on the recording state has already been explained, detailed explanations are omitted at this stage.

At step S130, the optical disc drive performs a focus jump based on the thresholds set at the step S120. It should be noted that if the focus jump operations have already been started, namely, if the operation at the step S80 has once been performed, it continues to move the focal point in the direction of focusing.

At step S140, the optical disc drive moves the optical pickup 3 to move the focal point of laser light from the focus landing point to the target position located on the same recording layer as the focus landing point.

In a focus jump to move the focal point of a light beam to a target recording layer, the optical disc drive in the first embodiment obtains the data recording state at the landing position of the focal point of a light beam and sets thresholds to be compared with a focus error signal based on the data recording state. It controls the focus jump based on the result of comparison of the focus error signal with the set thresholds, so that appropriate focus jump control is achieved corresponding to the level of the focus error signal.

Besides, if there is a recording layer for the focal point of a light beam to pass through during a focus jump, the optical disc drive obtains the data recording state at the transit point on the transit layer and sets thresholds based on the obtained data recording state. It controls the focus to pass through the recording layer in the focus jump based on the result of comparison of the focus error signal with the set thresholds, so that the optical disc drive in this embodiment can detect a recording layer and determines the passing through the recording layer with accuracy.

In particular, before performing a focus jump, the optical disc drive detects focus error signals in the cases of data recorded and no data recorded, and sets thresholds based on the detected signals and the data recording state at the landing point of the focal point of a light beam. Accordingly, the optical disc drive in this embodiment can set appropriate levels of thresholds to meet the level of the focus error signal.

Besides, the thresholds in the cases of data recorded and no data recorded are set for every recording layer, so that appropriate levels of thresholds can be set even if every recording layer has different reflectance.

### Second Embodiment

The optical disc drive in the first embodiment sets thresholds necessary for focus pull-in operations based on the recording state at the focus landing point and the recording state at the transit point on the transit layer at an inter-layer jump. An optical disc drive in a second embodiment fixes the thresholds necessary for focus pull-in operations and adjusts the value of the focus error signal based on the recording state at the focus landing point and the recording state at the transit point on the transit layer. The optical disc drive in the second embodiment has the same configuration as the optical disc drive in the first embodiment.

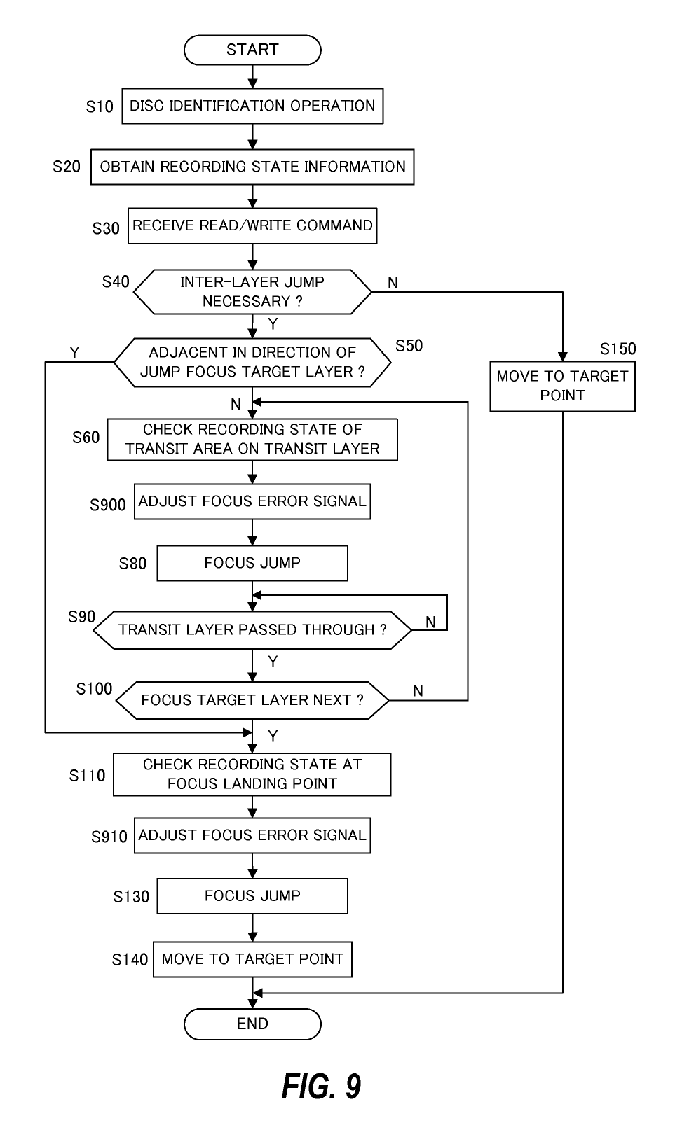

FIG. 9 is a flowchart illustrating a procedure to be executed by the optical disc drive in the second embodiment. The steps where the same operations are performed as those in the flowchart of FIG. 3 are denoted by the same signs and detailed explanations thereof are omitted. The operations in the flowchart of FIG. 9 different from those in the flowchart of FIG. 3 are the operations at steps S900 and S910.

At the step S900, the optical disc drive adjusts the value of the focus error signal based on the recording state at the transit point on the transit layer checked at the step S60.

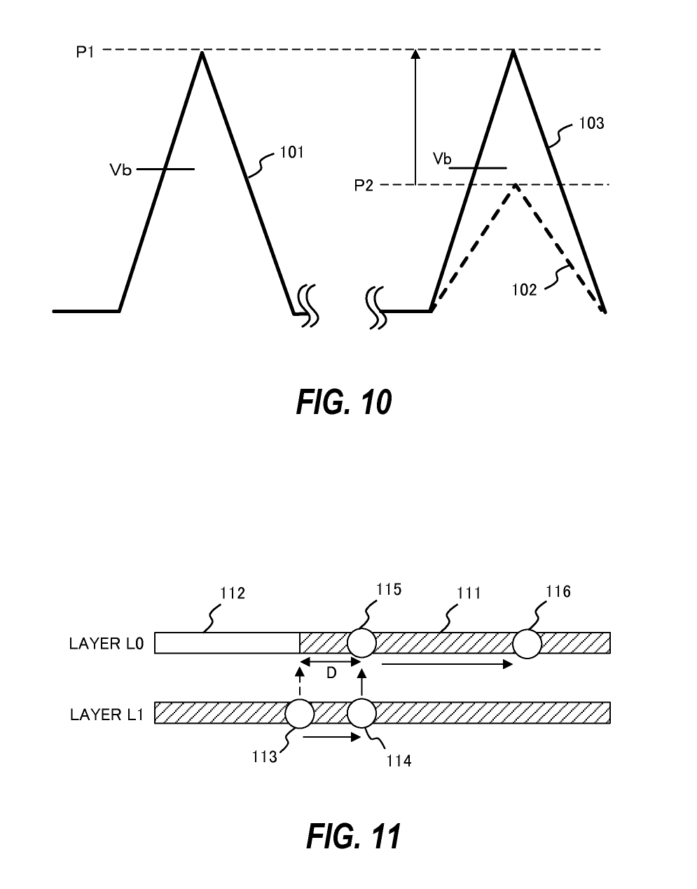

FIG. 10 is a diagram to illustrate a method of adjusting the value of the focus error signal based on the recording state at the transit point on the transit layer. In the diagram, the solid line 101 represents a part of the focus error signal in an area without data recorded and the dashed line 102 represents a part of the focus error signal in an area with data recorded.

The deceleration start threshold Vb (the threshold for recording layer detection) is set in advance at an appropriate value based on the focus error signal in the case of no data recorded. Namely, if data is not recorded at the transit point on the transit layer, the optical disc drive does not amplify the focus error signal, and if data is recorded, it amplifies the focus error signal.

In this example, in identifying an optical disc 1 after the disc is loaded in the optical disc drive, the optical disc drive detects a peak value P2 of the focus error signal in an area with data recorded and a peak value P1 of the focus error signal in an area without data recorded. It specifies the ratio P1/P2 between the detected peak values as the amplification factor. The solid line 103 in FIG. 10 represents a signal obtained by amplifying the focus error signal 102 in an area with data recorded with the amplification factor of P1/P2.

Although not shown in the drawing, the value of the focus error signal is adjusted on the negative side as well as the positive side. In other words, the optical disc drive sets in advance the acceleration stop threshold Va (the threshold for recording layer transit determination) at an appropriate value based on the focus error signal in the case of no data recorded, and amplifies the focus error signal with the amplification factor of P1/P2 if the transit point on the transit layer includes data recorded. It should be noted that the amplification factor may be P1′/P2′ or (P1+P1′)/(P2+P2′) where P2′ is the negative peak value of the focus error signal in an area with data recorded and P1′ is the negative peak value of the focus error signal in an area without data recorded.

The timing of adjusting the value of the focus error signal is the same as that of setting (changing) the thresholds Va and Vb in the first embodiment. That is to say, the optical disc drive adjusts the value of the focus error signal when it determines that the focal point has passed through the current recording layer.

Even after the optical disc drive adjusts the value of the focus error signal in an area with data recorded, the peak value may be different from the peak value in an area without data recorded. In such a case, the optical disc drive may set the thresholds in an area without data recorded at the above-described Va and Vb and set the thresholds in an area with data recorded based on the peak values of the focus error signals.

For example, assuming that the peak value of the focus error signal after the adjustment is P11 and the peak value of the focus error signal in an area without data recorded is P12, the thresholds in an area with data recorded may be set at Va×P11/P12 and Vb×P11/P12 respectively.

At the step S910 in the flowchart of FIG. 9, the optical disc drive adjusts the value of the focus error signal based on the recording state at the focus landing point checked at the step S110. Since the method of adjusting the value of the focus error signal based on the recording state has already been explained, detailed explanations are omitted at this stage.

In the above explanation, the optical disc drive does not amplify the focus error signal if data is not recorded at the transit point on the transit layer or the focus landing point, and amplifies the signal if data is recorded, but it may be vice versa. In such a case, the acceleration stop threshold Va (the threshold for recording layer transit determination) and the deceleration start threshold Vb (the threshold for recording layer detection) are set in advance based on the focus error signal in the case of data recorded. If data is recorded at the transit point on the transit layer or at the focus landing point, the optical disc drive does not amplify the focus error signal, and amplifies the focus error signal if data is not recorded. The amplification factor for the signal should be P2/P1 where P2 is the peak value of the focus error signal in an area with data recorded and P1 is the peak value of the focus error signal in an area without data recorded.

In a focus jump to move the focal point of a light beam to a target recording layer, the optical disc drive in the second embodiment obtains the data recording state at the landing point of the focal point of a light beam and adjusts the level of the focus error signal. It controls the focus jump based on the result of comparison of the adjusted focus error signal with the predetermined thresholds, so that appropriate focus jump control is achieved corresponding to the level of the focus error signal.

Besides, if there is a recording layer for the focal point of a light beam to pass through during a focus jump, the optical disc drive obtains the data recording state at the transit point on the transit layer and adjusts the level of the focus error signal based on the obtained data recording state. It controls the focal point to pass through the recording layer in the focus jump based on the result of comparison of the adjusted focus error signal with the set thresholds, so that the optical disc drive in this embodiment can detect a recording layer and determines the passing through the recording layer with accuracy.

In particular, before performing a focus jump, the optical disc drive detects focus error signals in the cases of data recorded and no data recorded and adjusts the level of the focus error signal based on the detected signals and the data recording state at the landing point of the focal point of a light beam. Accordingly, the optical disc drive in this embodiment can adjust the level of the focus error signal with accuracy.

### Third Embodiment

The optical disc drive in the first embodiment sets the thresholds necessary for focus pull-in operations in an inter-layer jump based on the recording state at the focus landing point. In this regard, an expected focus landing point in a focus jump may be around the border between an area with data recorded and an area with no data recorded. In this description, an area within a predetermined distance D in both directions across the tracks (hereinafter, across-track directions) from the boundary between an area with data recorded and an area without data recorded is referred to as “around border”. The distance D is determined in advance based on the amount of unique displacement in address for each recording layer, the amount of biased center unique to the optical disc 1, the amount of biased center generated in mounting the disc motor 2, and the like. For example, a little margin is added to the amount of unique displacement in address for each recording layer to determine the predetermined distance D.

If an expected focus landing point is around a border between an area with data recorded and an area without data recorded, the optical disc drive in a third embodiment performs a focus jump avoiding the border.

FIG. 11 is a diagram for illustrating a method of controlling a focus jump when the expected focus landing point corresponding to the initial focus point is around the border between an area 111 with data recorded and an area 112 without data recorded. The current focus point 113 of a light beam is on the layer L1 and the focus target point 116 is on the layer L0.

As shown in FIG. 11, if the optical disc drive performs a focus jump from the current focus point 113 of a light beam, the expected focus landing point is around the border between the area 111 with data recorded and the area 112 without data recorded. Accordingly, the optical disc drive first moves the focal point of a light beam to a point 114 on the same recording layer (the layer L1) which is at the predetermined distance D away from the boundary between the area with data recorded and the area without data recorded in the across-track direction. Then, it performs a focus jump from the point 114 where the focal point of the light beam has been moved, and moves the focal point of the light beam from the focus landing point 115 to the focus target point 116. Focus jump operations after moving the focal point of the light beam from the point 113 to the point 114 is the same as those in the first embodiment. It should be noted that the focus jump operations after moving the focal point of the light beam from the point 113 to the point 114 may be the same as those in the second embodiment.

If any transit layer exists in a focus jump and the transit point on the transit layer is around the border between an area with data recorded and an area without data recorded, the optical disc drive similarly avoids the border to perform the focus jump.

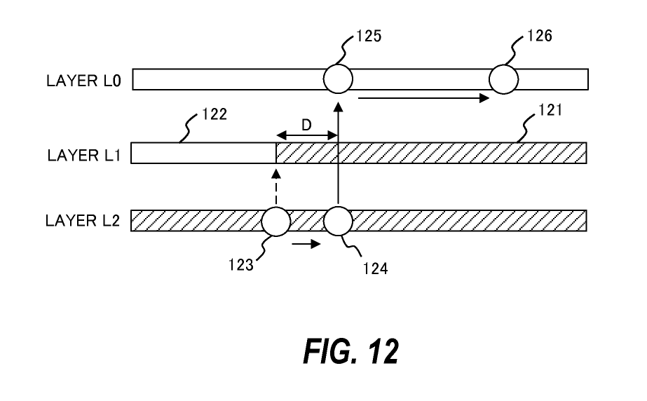

FIG. 12 is a diagram for illustrating a method of controlling a focus jump when the transit point on a transit layer corresponding to the initial focus point is around the border between an area 121 with data recorded and an area 122 without data recorded. The current focal point 123 of a light beam is on the layer L2 and the focus target point 126 is on the layer L0, and the layer L1 is a transit layer.

In this case, the optical disc drive first moves the focal point of a light beam to a point 124 on the same recording layer (the layer L2) so that the transit point on the transit layer (the layer L1) will be at a predetermined distance D away from the boundary between an area 121 with data recorded and an area 122 without data recorded in the across-track direction. Then, the optical disc drive performs a focus jump from the point 124 where the focal point of the light beam has been moved, and moves the focal point of the light beam from the focus landing point 125 to the focus target point 126. Focus jump operations after moving the focal point of the light beam from the point 123 to the point 124 are the same as those in the first embodiment. It should be noted that the focus jump operations after moving the focal point of the light beam from the point 123 to the point 124 may be the same as those in the second embodiment.

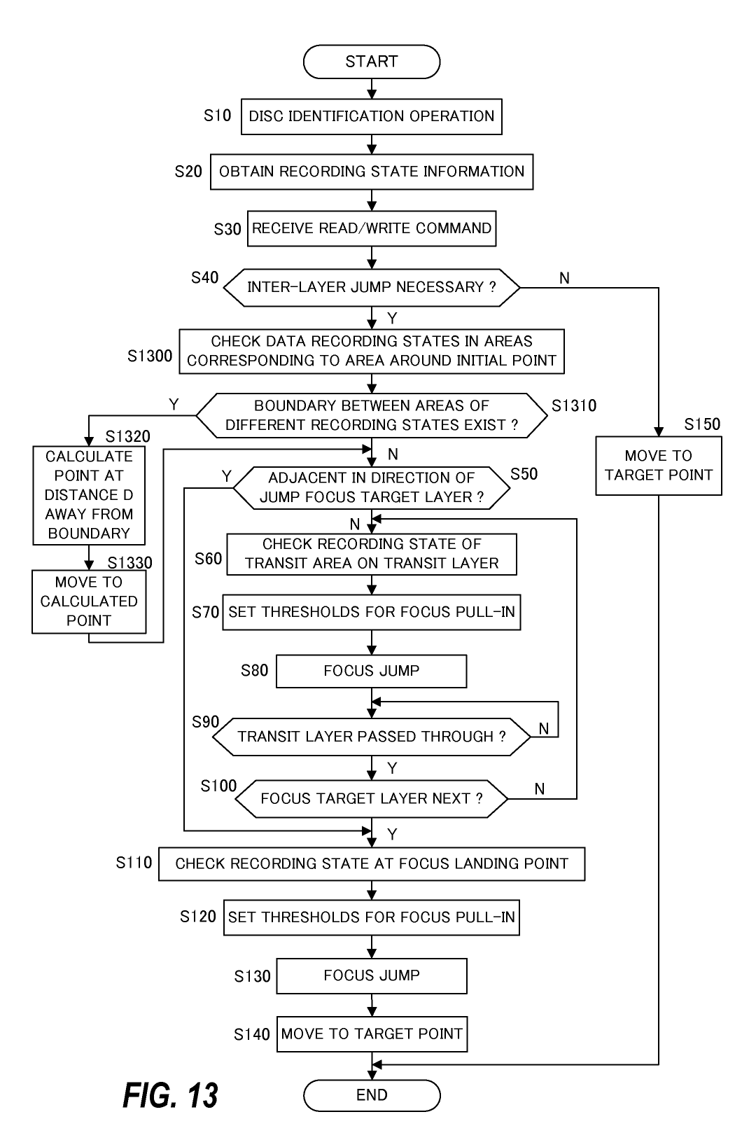

FIG. 13 is a flowchart illustrating a procedure executed by an optical disc drive in the third embodiment. The steps where the same operations are performed as those in the flowchart of FIG. 3 are denoted by the same signs and detailed explanations thereof are omitted. The operations in the flowchart of FIG. 13 different from those in the flowchart of FIG. 3 are the operations at steps S1300 to S1330.

At the step S1300, the optical disc drive checks the data recording states in the areas within the predetermined distance D in the across-track direction from the transit point on the transit layer and the expected focus landing point corresponding to the initial focus point.

At step S1310, it determines whether either the transit point on the transit layer or the expected focus landing point corresponding to the initial focus point is around the border between an area with data recorded and an area without data recorded based on the result of the check at the step S1300. Specifically, it refers to the information on the recording state of each data area obtained at the step S20 to determine whether any boundary between an area with data recorded and an area without data recorded exists in the range within the predetermined distance D in both the across-track directions from the transit point on the transit layer or the expected focus landing point corresponding to the initial focus point. If it has determined that there is a boundary between an area with data recorded and an area without data recorded, the procedure proceeds to step S1320, and if it has determined that there is not, the procedure proceeds to step S50.

At the step S1320, the optical disc drive calculates the point which is at the predetermined distance D away from the boundary between the area with data recorded and the area without data recorded in the across-track direction. At the step S1330, the optical disc drive moves the optical pickup 3 to move the focal point of laser light to the point calculated at the step S1320.

In a focus jump in which the transit point on the transit layer or the expected focus landing point is within a predetermined range from the boundary between an area with data recorded and an area without data recorded, the optical disc drive in the third embodiment moves the optical pickup to a point where the transit point on the transit layer and the expected focus landing point will not be in the predetermined range from the boundary in the across-track direction before starting the focus jump. Through these operations, the data recording states of recording layers can be reliably obtained. Accordingly, the optical disc drive can accurately set thresholds to be compared with a focus error signal depending on the recording states of the recording layers.

As set forth above, preferred embodiments of this invention have been described in detail with reference to the accompanying drawings; however, specific configurations are not limited to the embodiments but may include various designs within the scope of this invention. For example, the embodiments have described that the optical disc 1 has a characteristic that the values of the sum signal and the focus error signal corresponding to a recording layer with data recorded are lower than those corresponding to a recording layer without data recorded. However, this invention can be applied to an optical disc that has a characteristic that the values of the sum signal and the focus error signal corresponding to a recording layer without data recorded are lower than those corresponding to a recording layer with data recorded. In such a case, the thresholds Va and Vb to be compared with the focus error signal can also be set depending on the level of the focus error signal.

What is claimed is:

1. An optical disc drive for reading or writing information on a multilayer optical disc having a plurality of recording layers by irradiating the multilayer optical disc with a light beam, comprising:
an optical pickup for irradiating the multilayer optical disc with the light beam;
a focus error signal generator for generating a focus error signal that indicates a state of displacement of a focal point of the light beam from a recording layer of the multilayer optical disc based on reflection from the multilayer optical disc;
a recording state detector for detecting a data recording state at a landing point of the focal point of the light beam in a focus jump where the focal point of the light beam is moved to a target recording layer;
a threshold setting unit for setting a threshold to be compared with the focus error signal based on the data recording state at the landing point of the focal point of the light beam; and
a focus jump controller for controlling the focus jump based on a result of comparison of the focus error signal with the threshold set by the threshold setting unit.

2. The optical disc drive according to claim 1, wherein:
the recording state detector detects a data recording state at a transit point on a recording layer through which the focal point of the light beam passes if the recording layer through which the focal point of the light beam passes exists in the focus jump;
the threshold setting unit sets the threshold to be compared with the focus error signal when the focal point of the light beam passes through the recording layer based on the data recording state at the transit point; and
the focus jump controller controls the focal point of the light beam passing through the recording layer in the focus jump based on the result of comparison of the focus error signal with the threshold set by the threshold setting unit.

3. The optical disc drive according to claim 1, wherein the threshold setting unit sets a threshold in a case of data recorded and a threshold in a case of no data recorded for each of the plurality of recording layers.

4. The optical disc drive according to claim 1, wherein, in performing the focus jump, if either one of a landing point when the focal point of the light beam is moved to a target layer or a transit point on a recording layer through which the focal point of the light beam passes is within a predetermined range in across-track directions from a boundary between an area with data recorded and an area with no data recorded, the focus jump controller moves the optical pickup to a position where neither the landing point when the focal point of the light beam is moved to the target layer nor the transit point on the recording layer through which the focal point of the light beam passes are within the predetermined range from the boundary before performing the focus jump.

5. An optical disc drive for reading or writing information on a multilayer optical disc having a plurality of recording layers by irradiating the multilayer optical disc with a light beam, comprising:
an optical pickup for irradiating the multilayer optical disc with a light beam;
a focus error signal generator for generating a focus error signal that indicates a state of displacement of a focal point of the light beam from a recording layer of the multilayer optical disc based on reflection from the multilayer optical disc;
a recording state detector for detecting a data recording state at a landing point of the focal point of the light beam in a focus jump where the focal point of the light beam is moved to a target recording layer;
a signal adjuster for adjusting a level of the focus error signal based on the data recording state at the landing point of the focal point of the light beam; and
a focus jump controller for controlling the focus jump based on a result of comparison of the focus error signal adjusted by the signal adjuster with a predetermined threshold.

6. The optical disc drive according to claim 5, wherein:
the recording state detector detects a data recording state at a transit point on a recording layer through which the focal point of the light beam passes if the recording layer through which the focal point of the light beam passes exists in the focus jump;
the signal adjuster adjusts a level of the focus error signal based on the data recording state at the transit point; and
the focus jump controller controls the focal point of the light beam passing through the recording layer in the focus jump based on the result of comparison of the focus error signal adjusted by the signal adjuster with the predetermined threshold.

7. The optical disc drive according to claim 5, further comprising a threshold setting unit for determining a level of the predetermined threshold based on the focus error signal adjusted by the signal adjuster.

8. The optical disc drive according to claim 5, wherein, in performing the focus jump, if either one of a landing point when the focal point of the light beam is moved to a target layer or a transit point on a recording layer through which the focal point of the light beam passes is within a predetermined range in across-track directions from a boundary between an area with data recorded and an area with no data recorded, the focus jump controller moves the optical pickup to a position where neither the landing point when the focal point of the light beam is moved to the target layer nor the transit point on the recording layer through which the focal point of the light beam passes are within the predetermined range from the boundary before performing the focus jump.

9. A method of controlling an optical disc drive for reading or writing information on a multilayer optical disc having a plurality of recording layers by irradiating the multilayer optical disc with a light beam, comprising the steps of:
generating a focus error signal that indicates a state of displacement of a focal point of the light beam from a recording layer of the multilayer optical disc based on reflection from the multilayer optical disc;
detecting a data recording state at a landing point of the focal point of the light beam in a focus jump where the focal point of the light beam is moved to a target recording layer;
setting a threshold to be compared with the focus error signal based on the data recording state at the landing point of the focal point of the light beam; and
controlling the focus jump based on a result of comparison of the focus error signal with the threshold.

10. A method of controlling an optical disc drive for reading or writing information on a multilayer optical disc having a plurality of recording layers by irradiating the multilayer optical disc with a light beam; comprising the steps of:
generating a focus error signal that indicates a state of displacement of a focal point of the light beam to a recording layer of the multilayer optical disc based on reflection from the multilayer optical disc;
detecting a data recording state at a landing point of the focal point of the light beam in a focus jump where the focal point of the light beam is moved to a target recording layer;
adjusting a level of the focus error signal based on the data recording state at the landing point of the focal point of the light beam; and
controlling the focus jump based on a result of comparison of the adjusted focus error signal with a predetermined threshold.
